(19) United States
(12) Patent Application Publication
(10) Pub. No.: US 2018/0225757 A1
(43) Pub. Date: Aug. 9, 2018

(54) INTERNET-BASED CURRENCY EXCHANGE AND SETTLEMENT METHOD AND SYSTEM

(71) Applicant: HANGZHOU PINGPONG INTELLIGENT TECHNICAL CO., LTD, Hangzhou, Zhejiang (CN)

(72) Inventors: Peng CHEN, Hangzhou, Zhejiang (CN); Wei XIONG, Hangzhou, Zhejiang (CN)

(73) Assignee: HANGZHOU PINGPONG INTELLIGENT TECHNICAL CO., LTD, Hangzhou, Zhejiang (CN)

(21) Appl. No.: 15/750,341

(22) PCT Filed: May 25, 2016
(86) PCT No.: PCT/CN2016/083233

§ 371 Date: Apr. 10, 2018

(30) Foreign Application Priority Data
Aug. 5, 2015 (CN) 201510474541.2

(51) Int. Cl. G06Q 40/04

(52) U.S. Cl. CPC G06Q 40/04

(57) ABSTRACT

Disclosed is an Internet-based currency exchange and settlement system, comprising: at least two legal tender nodes, used for receiving an exchange request of a client and sending the exchange request to other legal tender nodes; an electronic currency node, used for circulation between electronic currency and legal tender; a balancing module, used for establishing an exchange path between the electronic currency node and a corresponding legal tender node, and maintaining the balance of expenditure and income of the corresponding legal tender node; a searching module, used for retrieving a legal tender node sending an exchange request within a same time interval; a matching module, used for exchange matching between the legal tender nodes and between the legal tender nodes and the electronic currency node. Also disclosed is an Internet-based currency exchange and settlement method. The present invention is targeted towards the requirements of international travellers having actual legal tender requirements, is based on a big data cashing requirement value chain network smart internal aggregation algorithm, and delivers exchanged destination legal tender to a user via a physical terminal of a target country location.

### FIELD

The present disclosure relates to the technical field of currency exchange and settlement, and in particular to an internet-based currency exchange and settlement method and an internet-based currency exchange and settlement system.

### BACKGROUND

With the increasing Chinese openness to the outside world, more and more Chinese go abroad, and the activities of foreign individuals in China have greatly increased. Over the years, the strict foreign exchange management of China has gradually eased, and the restriction on personal use of foreign exchange is loosened to satisfy personal substantial needs of foreign currencies. In 1994, the unified national interbank foreign exchange market was established, which completely changed the situation of the segmented foreign exchange markets and non-uniform exchange rates and laid the foundation for a unitary, well-managed floating exchange rate system based on market supply and demand. In recent years, with the acceleration of internationalization of Renminbi, many commercial banks have already obtained market maker qualifications for direct trading between Renminbi and non-dollar currencies, which consolidates the competitive advantage of Chinese foreign exchange business as an important progress of internationalization of Renminbi.

However, for historical reasons, the existing foreign exchange market in China is a closed market system centered on the inter-bank market and controlled by the government in many aspects of foreign exchange transactions, which causes problems such as insufficient market competition and low efficiency. The existing foreign exchange market mainly refers to a market for foreign exchange trade and settlement supplement to the domestic interbank foreign exchange market. At present, there are many restrictions on transactions in the foreign exchange market. Under such circumstance, free choices of traders are limited and it is difficult to ensure continuity of transactions, also the coverage is narrow and the cost of intra-market trading organization is high. Therefore, a free-market transaction is not actually achieved, and the foreign exchange market of China needs to be further opened and innovated due to the shortcomings existed.

With the expansion of foreign communication activities, foreign-related contacts and personnel cross-border movements are increased and the demand for exchanges between the home and foreign currencies is increased. Against this background, a personal home-foreign currency exchange franchising company which serves as a beneficial complement for the foreign currency exchange system helps to improve the efficiency of personal foreign currency exchange in the jurisdiction of the company, and meet requirements from foreign-related services. In order to meet the growing requirements on personal home-foreign currency exchange, the State Foreign Exchange Administration of the People's Republic of China carried out franchises pilot programs of personal home-foreign currency exchange in Beijing and Shanghai in August 2008. The pilot region was expanded to thirteen provinces, cities and autonomous regions and 4 municipalities with independent planning status in November 2009. According to relevant state regulations, the policy for personal home-foreign currency exchange business has been liberalized. That is, all non-financial enterprises meeting admission conditions can apply for a license to offer personal home-foreign currency exchange franchise services, and the licensed enterprises can offer personal home-foreign banknotes exchange services. The 24-hour service of the currency exchange company can make up for the shortcoming of strictly-restricted business hours at branches of the bank. However, the currency exchange companies operate at a high cost and provide a quotation price even higher than the bank, and some companies charge fees for home-foreign currency exchange services, since currency branches have a high operating cost due to a large quantity of sites and staffs. Therefore, the currency exchange companies have not so many competitive advantages when compared with the bank. Therefore, it is difficult for users to accept the currency exchange company.

Currency exchange is an old concept, which is proposed after the appearance of commodity exchange for adapting to international economic activities. The currency exchange can be traced back to the early exchange among various metal currencies. Since the 19th century, major western countries practiced the gold standard system. In this system, the currency can be freely exchanged and circulated in the world. This is called free currency exchange.

For a long time, Chinese Renminbi has been identified as a non-exchangeable currency by the international community. With the continuous reforming and opening of China and the rapid growth of the international balance of payments and foreign exchange reserves, the economic relations between China and other countries in the world become increasingly closer, and the free exchange of Renminbi is put on the agenda. On Jan. 1, 1994, China introduced a reform of foreign exchange management system, and clearly pointed out that the ultimate goal of the reform is to achieve the fully free exchange of Renminbi. At the end of 2013, the central bank of China issued “the Opinions on the Financial Support for the Construction of China (Shanghai) Pilot Free Trade Zone”, based on which cash can be freely transferred between a resident account within the free trade zone and an oversea account, a domestic non-resident account outside the free trade zone, a non-resident account within the free trade zone as well as an account of another resident within the free trade zone. A cash flow between the resident account within the free trade zone and a domestic bank settlement account outside the free trade zone is managed as a cross-border business. This opened the door to free currency exchange. Meanwhile, storages and transfers of multiple currencies may be freely achieved with one account with the popularization of multi-currency bank card in the world.

Currently, there are many problems in the traditional currency exchange performed at the bank counter, such as a complicated procedure, long queuing time, short business hours and poor service quality. At present, the franchising exchange business is opened up in some cities in China, but is difficult to popularize due to few physical branches and high exchange fees.

With the rapid development of computer and network communication technologies, the internet technology is gradually applied in various human activities, and many innovative modes are provided, such as computerized finance. The computerized finance means that a financial enterprise adopts the internet technology represented by information technologies such as current communication, computers and networks, to improve the efficiency of traditional financial services and reduce the operating cost, thereby achieving automatized financial business processing, computerized management of the financial enterprise and scientific decision-making, to provide customers with fast and convenient services. Therefore, the market competitiveness of the financial institution is improved. The electronic finance is a transcendence of the computerized finance. Unlike the computerized finance, the electronic finance operates mainly based on the increasingly sophisticated internet technology. Due to the global connectivity, openness, fastness and low marginal cost of the internet technology, the electronic finance places greater emphasis on the reorganization and innovation of the entire financial service business based on the internet technology, so that customers can enjoy high quality and low cost services provided by the financial enterprises at all times and places without being limited by business hours and business places. With the development of the electronic finance based on the internet, the currency has a more virtualized form, such as electronic currency which exists only in the form of electronic signal instead of any entity.

In the conventional technology, Chinese Patent Publication No. CN104392348A, titled “Digital currency-based cross-border payment and clearing system and cross-border payment method” discloses a cross-border payment and clearing system in which the payment and clearing are performed based on digital currency and counterparty transaction of members. With the system, a high-speed and low-cost cross-border payment is achieved by converting legal tender to digital currency and performing counterparty transaction with a member company in a target country of the payment. The method is applied in the field of electronic commerce, and relates to only single-direction payment, exchange and settlement without the withdrawal of the actual legal currency.

### SUMMARY

Electronic currency serves as a technical medium for convenient exchange between different types of legal tender through the internet. According to the present disclosure, an internet-based electronic currency exchange and pre-settlement method is provided, where the electronic currency is taken as a medium, and currency exchange and settlement requirements of users in different countries are acquired based on the internet. When a user needs to perform currency exchange and settlement, convenient exchange between local legal tender of the user and destination legal tender can be performed through a system platform by taking the electronic currency as a medium. In addition, in a case that there are exchange and settlement requirements at both the location of the user and the destination, the system may perform a rapid exchange between the local currency in two accounts at equal values, thereby avoiding exchange rate losses caused by multiple exchanges and providing convenient currency services to customers. Then, the exchanged legal tender is transferred to the bank account of the user, and the user may withdraw the target legal tender obtained by exchange at a local terminal of the destination country on arrival at the destination country. In this case, problems in the conventional exchange performed at the counter, such as few service branches, limited business hours, excessive intermediate links, complicated procedures, exchange rate losses and high fees, can be avoided.

Technical solutions according to the present disclosure are described as follows.

An internet-based currency exchange and settlement method is provided, which includes:

exchanging legal tender based on electronic currency, including:
determining an exchange rate between held legal tender and target legal tender based on an exchange rate between the held legal tender and the electronic currency and an exchange rate between the target legal tender and the electronic currency, and
performing legal tender exchange between the held legal tender and the target legal tender by taking the electronic currency as a medium; and

exchanging legal tender based on a period, including:
in a case where a customer A requests for exchange for the target legal tender, searching for a customer B holding the target legal tender and requesting for exchange in a same period, and
performing legal tender exchange between the held legal tender and the target legal tender based on the exchange rate between the held legal tender and the electronic currency and the exchange rate between the target legal tender and the electronic currency.

Preferably, it may be evaluated whether the target legal tender and the held legal tender are in balanced circulation based on a currency flow corresponding to the target legal tender and a currency flow corresponding to the held legal tender. The currency flow represents an amount of inputted currency or outputted currency.

Preferably, a currency flow representing that the held legal tender is exchanged for the target legal tender via the electronic currency may be established, in a case where an amount of the held legal tender exchanged for the target legal tender is greater than an amount of held legal tender exchanged from the target legal tender.

The method according to the present disclosure is for international travelers having actual legal tender requirements and is based on a big data-based exchange requirement value chain network intelligent intra-aggregation algorithm. Destination legal tender obtained by exchange is delivered to the user via a physical terminal in the destination country.

An internet-based currency exchange and settlement system is further provided according to the present disclosure, which includes:

at least two legal tender nodes, where each of the legal tender nodes is configured to receive an exchange request from a customer and send the exchange request to another one of the legal tender nodes;

an electronic currency node, configured for circulation between electronic currency and legal tender;

a balancing module, configured to establish an exchange path between the electronic currency node and one of the legal tender nodes, to maintain balance between output and input of the legal tender node;

a search module, configured to search for the legal tender node sending an exchange request in a same period as the received exchange request; and

a matching module, configured to match the legal tender nodes with each other or match one of the legal tender nodes with the electronic currency node for performing exchange.

The currency exchange and settlement system according to the present disclosure has a unified exchange platform, where the legal tender nodes, the electronic currency node, the balancing module, the searching module and the matching module are all visual functional units of the exchange platform. After an exchange request from a customer is received by the legal tender node (including a bank, an ATM or another third-party payment mechanism), the searching module searches for anther legal tender node sending an exchange request in a same period, the matching module matches the legal tender node and the found legal tender node for performing intra-platform legal tender exchange, and the exchange between the matched legal tender nodes is performed based on an exchange rate. In a case of unbalance exchange, the balancing module establishes an electric currency node which performs exchange with a corresponding legal tender node, to maintain a balance between the exchange requirement and an amount of currency in circulation at the legal tender node, thereby achieving a value chain balance of the entire exchange platform, that is, meeting currency exchange requirements of all customers with a minimum amount of money flows.

Preferably, the currency exchange and settlement system may further include an exchange rate calculation module configured to calculate an exchange rate between legal tender and electronic currency and an exchange rate between legal tender and another type of legal tender. During currency exchange, the electronic currency is used as a medium or reference, and the exchange between different types of legal tender is performed by determining an exchange rate between the held legal tender and the target legal tender based on the exchange rate between the held legal tender and the electronic currency and the exchange rate between the target legal tender and the electronic legal tender.

Preferably, each of the legal tender nodes is connected to a currency flow monitoring module configured to monitor an output flow and an input flow of legal tender and provide the flow data to the balancing module. The balancing module is configured to establish an exchange path between the electronic currency and the legal tender based on a signal from the currency flow monitoring module, to maintain balance between inflow and outflow of the legal tender.

Preferably, the exchange platform according to the present disclosure may further include a time management module configured to manage a time cycle for currency exchange. The exchange platform may optimize the time cycle for exchange based on exchange requirements in different periods, such that a total amount of legal tender inputted by the electronic currency node to the legal tender nodes is minimum. That is, the amount of actual exchange value flows is minimum, thereby further reducing the exchange rate loss of the system.

The object of the present disclosure is to provide an internet-based electronic currency exchange and pre-settlement system based on a time constraint-based target currency requirement matching method and a big data-based exchange requirement value chain network intelligent intra-aggregation algorithm, where the electronic currency is used as the medium. With the method, local legal tender of the user can be exchanged with destination legal tender rapidly and conveniently, and the user may withdraw the destination legal tender obtained by exchange at a local terminal of the destination country on arrival at the destination country. In this case, problems in the conventional exchange and settlement between currencies of different countries performed over the counter, such as few service branches, limited business hours, excessive intermediate links, complicated procedures, exchange rate losses and high fees, can be avoided.

### BRIEF DESCRIPTION OF THE DRAWINGS

FIG. 1 is a schematic diagram illustrating a principle of a system according to the present disclosure;

FIG. 2 is a schematic structural diagram of a system according to the present disclosure;

FIG. 3 is a flowchart illustrating operation logics according to the present disclosure;

FIG. 4 is a topology of chain value flows of multi-direction currency exchange;

FIG. 5 is a schematic structural diagram of a big data-based exchange requirement value chain network intelligent intra-aggregation algorithm; and

FIG. 6 is a schematic diagram of a simple network formed by a node A, a node B and an exchange platform E.

### DETAILED DESCRIPTION OF EMBODIMENTS

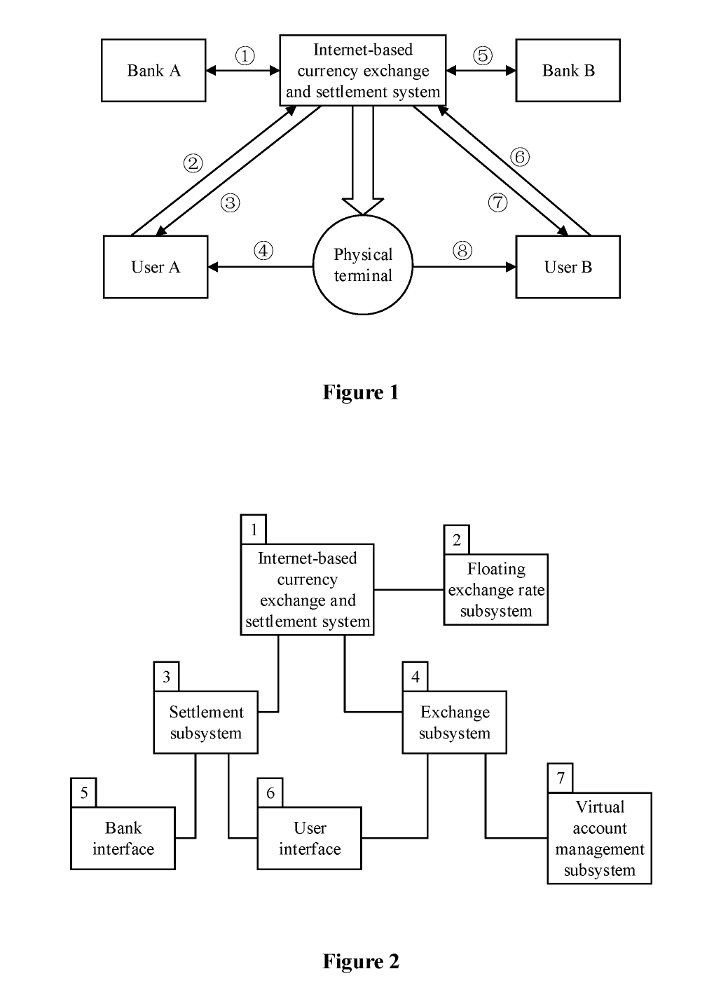

As shown in FIG. 1, circulation between an internet-based currency exchange and settlement system according to the present disclosure and a bank A is achieved via settlement \textcircled{1} between the bank A and the system, and circulation between the internet-based currency exchange and settlement system according to the present disclosure and a bank B is achieved via settlement \textcircled{5} between the bank B and the system. A user A inputs real currency A\textcircled{3} to the currency exchange and settlement system, for exchange for electronic currency \textcircled{3}, and target legal tender A\textcircled{4} obtained by exchange is provided to the user A via a terminal entity. A user B inputs real currency B\textcircled{6} to the currency exchange and settlement system, for exchange for electronic currency \textcircled{7}, and target legal tender B\textcircled{8} obtained by exchange is provided to the user B via a terminal entity.

The principle of the above currency exchange and settlement system is described below. A customer A has an account of a bank A, a customer B has an account of a bank B. The customer A and the customer B respectively hold legal tender C and legal tender D. The customer A wants to exchange his/her legal tender C for the legal tender D held by the customer B. Exchange and settlement of legal tender is performed between the customer A and the customer B with the internet-based currency exchange and settlement system according to the present disclosure, and the system transfer target legal tender with equal value respectively to the bank account of the customer A and the bank account of the customer B via interfaces.

In order to achieve the above function, as shown in FIG. 2, the system according to the present disclosure includes: an internet-based currency exchange and settlement system 1, a floating exchange rate subsystem 2, a settlement subsystem 3, an exchange subsystem 4, a bank interface 5, a user interface 6 and a virtual account management subsystem 7.

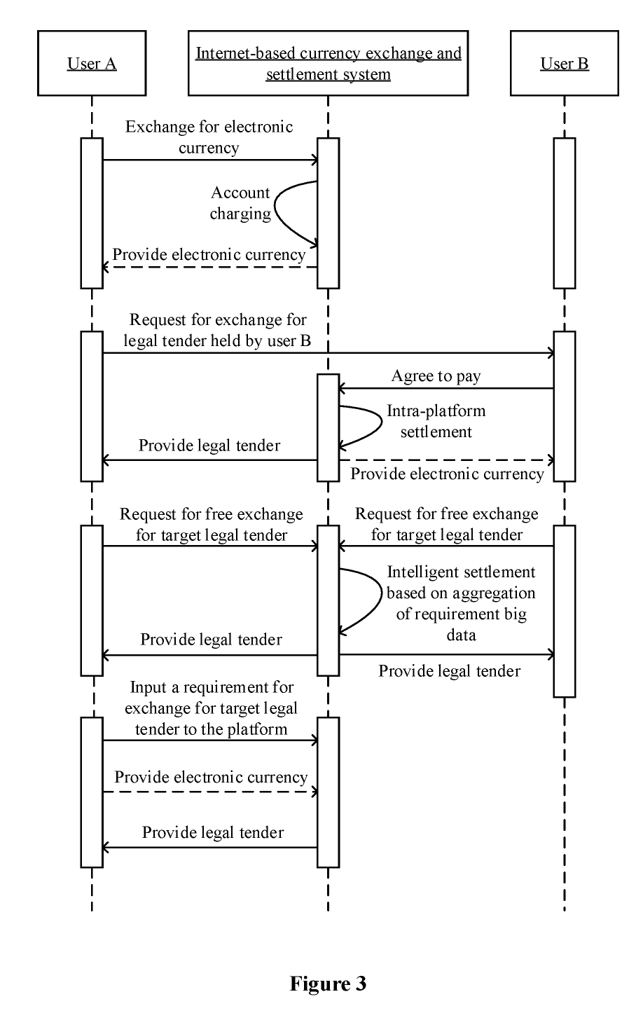

An implementation according to the present disclosure is described below in conjunction with FIG. 3.

A platform allows the user to register an on-line account and deposit a certain amount of money. The platform may provide different exchange rates for the user to select, of which the form is similar to a competitive tender. If the customer and the platform agree on the exchange rate, which means that the customer has determined to exchange legal tender using the platform, the platform may perform corresponding operations when an exchange object is found.

Taking big currency (such as Renminbi and dollar) which is frequently exchanged as an example. It is assumed that A is an American resides in New York and is sent by his/her company to Beijing China for a business negotiation with a cooperative partner, then A needs to exchange dollars in his/her bank account for a sum of Renminbi for daily expenses in China. In addition, it is assumed that B is a Chinese working in Shanghai China and plans to travel to America with his/her family recently, then B needs to exchange his/her Renminbi for dollars, for expenses in the USA. In this case, A and B only need to deposit currencies they hold into corresponding accounts. Accounts information of A and B presents amounts of the destination legal tender which may be obtained by A and B after exchange based on the exchange rate provided by the platform, respectively. If neither A nor B has an objection, A can receive a confirmation of transformation of money to his/her account in the USA bank within one to two days, the same is true of B in Shanghai China.

If a user matching an exchange requirement of a customer C cannot be found, the system provides a unilateral free exchange mode. That is, the customer C issues the exchange requirement on the platform. If a customer D agrees to exchange his/her legal tender for electronic currency hold by the customer C, the customer C can obtain target legal tender of the required amount after paying a corresponding amount of electronic currency by means of the system.

If a customer E requires an exchange regarding small currency, the requirement for the target currency may not be matched (i.e., no exchanging requirement for the currency held by C in a region where the target currency is used). The above two modes cannot meet the requirement of the customer. In this case, the requirement of the customer may be met by the system with reserve currency of the system, and a certain amount of exchange fee is charged.

The legal tender exchange modes in this embodiment includes an electronic currency-based legal tender exchange rate dynamical calculation method, a time constraint-based target currency requirement matching method and a big data-based exchange requirement value chain network intelligent intra-aggregation algorithm.

1. The Electronic Currency-Based Legal Tender Exchange Rate Dynamical Calculation Method

In traditional exchange performed at a bank counter, legal tender A held by a customer is first exchanged for dollars, and then the dollars are exchanged for target legal tender B. In this case, exchange is performed two times. The procedure is complicated, and there is exchange rate loss. With the legal tender exchange method based on electronic currency, an exchange rate between the held legal tender A and the target legal tender B is directly calculated by taking the system electronic currency as a medium, thereby avoiding the complicated exchange procedure and the exchange rate loss. The algorithm for the legal tender exchange method based on electronic currency is as follows. Given that an exchange rate between the legal tender A and the system electronic currency is 1:N, and an exchange rate between the legal tender B and the system electronic currency is 1:M, an exchange rate between the legal tender A and the legal tender B is M:N, where N and M float based on the international exchange rate.

2. The Time Constraint-Based Target Currency Requirement Matching Method

Since the currency requirement of the customer is limited to a period, a time-based exchange requirement matching method is provided by taking the period limitation into consideration, which includes performing matching in a requirement pool in which types of the currency match with each other (i.e., types of the currency required by both parties involved in the requirement match with each other) with respect to periods of the requirements. In a case where the requirement of a customer A is limited to a period X, and the requirement of a customer B is limited to a period Y, the requirements of customer A and customer B meet a time constraint and can be matched with each other if there is overlap between X and Y, and the requirements of customer A and customer B do not meet the time constraint and cannot be matched with each other if there is no overlap between X and Y.

3. The Big Data-Based Exchange Requirement Value Chain Network Intelligent Intra-Aggregation Algorithm

When a customer provides the required target legal tender, an exchange period and an exchange amount based on his/her requirement, the system may perform user requirement big data-based intelligent intra-aggregation on the exchange requirements in the same period using the time constraint-based target currency requirement matching method. Specifically, if a customer 1 holds currency A equivalent to electronic currency in an amount of β₁ and wants to exchange currency A for currency B, the requirement of the customer A may be defined as

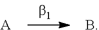

Similarly, the requirement of a customer 2 may be defined as

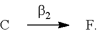

In this manner, a multi-direction chain value flow network may be defined for exchange requirements of a large group.

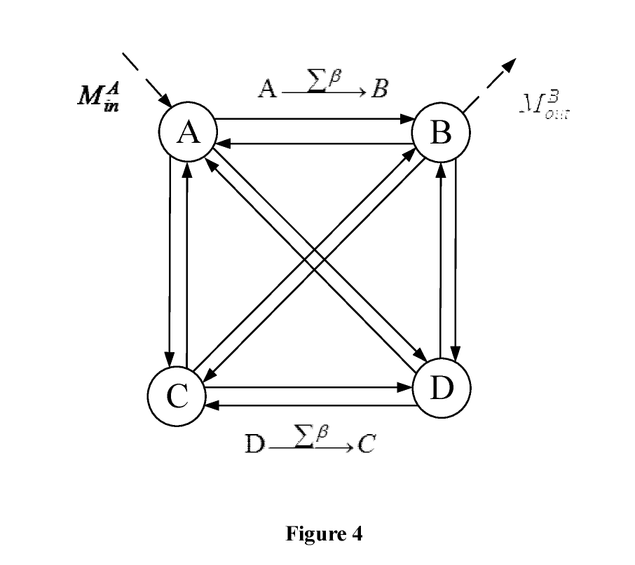

As shown in FIG. 4, each vertex of the network represents a type of legal tender. That is, A, B, C and D respectively represent four types of legal tender. Each side represents a sum of exchange requirements from original legal tender to final legal tender.

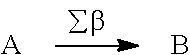

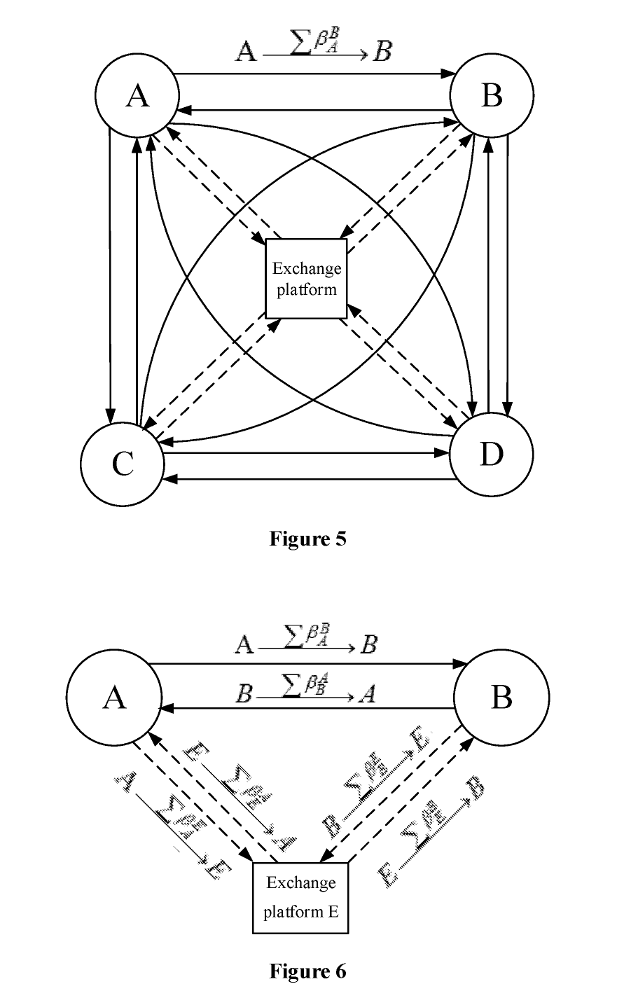

in FIG. 5 represents a sum of exchange requirements from legal tender A to legal tender B of all users within a certain period, which is obtained with the time constraint-based target currency requirement matching method. If there is no exchange requirement,

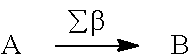

represented by this side equals to zero. With the above method, a big data network of exchange requirement value chains is established. Generally, value flows in the network are unbalanced, which causes requirements of a portion of users cannot be met. However, the network inevitably includes a series of vertexes, and the value flows in the network may be balanced by inputting or outputting a certain amount of legal tender at the vertexes (such as an inputted legal tender flow Mᵢₙ^{A} represented by the dot and dash line in FIG. 4 and an outputted legal tender flow Mₒᵤₜ^{B} represented by the dashed line in FIG. 4). In this case, the exchange requirements of all customers in the network can be met. Based on the above algorithm, the system can meet the exchange requirements of all of the users with a minimum inputted real legal tender flow and a minimum outputted real legal tender flow. An implementation of the above big data-based exchange requirement value chain network intelligent intra-aggregation algorithm is shown in FIG. 5.

The big data network model of exchange requirement value chains established with the above method is generally unbalanced. That is, within a period, exchange requirements of all of the users in the network cannot be met based on only legal tender value flows provided by the users. Certain legal tender needs to be inputted or outputted at some nodes to meet the exchange requirements of all of the users for balancing requirements of the entire exchange value chain network, that is, meeting the exchange requirements of all of the users. Therefore, in the present disclosure, based on the above electronic currency-based legal tender exchange rate dynamical calculation method, the exchange platform is introduced into the exchange value chain network as an intermediate input/output node, to balance the entire exchange value chain network. Hereinafter, an implementation of the method is described based on a simple network formed by a node A, a node B and an exchange platform E with reference to FIG. 6.

In FIG. 6, for a node A,

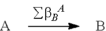

represents total exchange requirements from legal tender A to legal tender B in a certain period, where Σβ_{B}^{A} represents the amount of legal tender A to be exchanged for legal tender B.

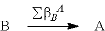

represents total exchange requirements from legal tender B to legal tender A in a corresponding period, where Σβ_{B}^{A} represents the amount of legal tender B to be exchanged for legal tender A. In this case, in the exchange loop formed by only the node A and the node B, the requirements that can be met by only currency exchange between customers is expressed as Min(Σβ_{B}^{A},Σβ_{A}^{B}), where Min(⋅) represents a smaller one of two values, and the requirements which are not met are expressed as Max(Σβ_{B}^{A},Σβ_{A}^{B})−Min(Σβ_{B}^{A},Σβ_{A}^{B}), where Max(•) represents a greater one of two values. In order to balance the exchange value chains of the simple network formed by the node A, the node B and the exchange platform E, value flows indicated by the dashed lines need to be formed. In FIG. 6, it is assumed that Σβ_{B}^{A}≤Σβ_{A}^{B}, that is, the amount of exchange requirements from legal tender A to legal tender B is greater than the amount of exchange requirements from legal tender B to legal tender A. Then, the following value chain flow needs to be formed: the legal tender node A→the exchange platform E→the legal tender node B, that is,

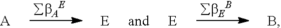

where the value measured with electronic currency of the exchange platform is maintained constant, that is, Σβ_{A}^{E=Σβ}_{E}^{B}=Max(Σβ_{B}^{A},Σβ_{A}^{B})−Min(Σβ_{B}^{A},Σβ_{A}^{B}) =Σβ_{A}^{B}−Σβ_{B}^{A}, and Σβ_{E}^{A}=Σβ_{B}^{E}=0. In other words, the exchange platform provides the electronic currency as an intermediate medium to the customer, to meet the part of the exchange requirements from legal tender A to legal tender B which is not met. In the simple network formed by the node A, the node B and the exchange platform E, the effect of big data aggregation is not demonstrated. Hereinafter, the aggregation effect is described by taking a more complicated network formed by a node A, a node B, a node C, a node D and an exchange platform E as an example. As can be seen from the simple network formed by the node A, the node B and the exchange platform E, for the node A, all unmet exchange requirements is obtained by subtracting a sum of exchange requirements from all the nodes in the network expect for the exchange platform node E to the node A from a sum of exchange requirements from node A to all the nodes in the network except for the exchange platform node E, that is, Mₒᵤₜ^{A}=(Σβ_{A}^{B}−Σβ_{B}^{A}) +(Σβ_{A}^{C}−Σβ_{C}^{A})+(Σβ_{A}^{D}−Σβ_{D}^{A}). If Mₒᵤₜ^{A}<0, it means that, for the exchange requirements of legal tender A in the period, an amount of out-flow value is greater than an amount of in-flow value. That is, the sum of requirements for exchanging legal tender A for other currencies is greater than the sum of requirements for exchanging other currencies for legal tender A. In order to maintain the balance of the value flows of the network, the value chain of the difference regarding the legal tender A is taken by the intermediate exchange node platform node E. In other words, the exchange platform node E extracts legal tender A having a value equivalent to Mₒᵤₜ^{A} from the node A. If Mₒᵤₜ^{A}<0, it means that, for the exchange requirements of legal tender A in the period, an amount of out-flow value is less than an amount of in-flow value. That is, the sum of requirements for exchanging legal tender A for other currencies is less than the sum of requirements for exchanging other currencies for legal tender A. In order to maintain the balance of the value flows of the network, the value chain of the difference regarding the legal tender A is provided by the intermediate exchange platform node E. In other words, the exchange platform node E provides legal tender A having a value equivalent to Mₒᵤₜ^{A} for the node A. Similarly, Mₒᵤₜ^{B}, Mₒᵤₜ^{C} and Mₒᵤₜ^{D} can be obtained, which respectively represent the amounts of legal tender B, legal tender C and legal tender D that exchange platform node E needs to provide/extract.

In addition, the exchange platform may optimize a time cycle for exchange (i.e., change an exchange time constraint) based on exchange requirements of different periods, to obtain a minimum Mₒᵤₜ^{A}+Mₒᵤₜ^{B}+Mₒᵤₜ^{C}+Mₒᵤₜ^{D}, i.e., a minimum amount of exchange value flows, thereby further reducing the exchange rate loss of the system.

Based on the above technology, the exchange platform node E provides or extracts a certain amount of legal tender to or from the legal tender node in a period, to balance value chains of the exchange network, thereby meeting currency exchange requirements of all customers with a minimum amount of exchange value flows.

What is described above is only preferred embodiments of the present disclosure and is not intended to limit the present disclosure. Any modifications, equivalents and improvements made to the embodiments without deviation from the spirit and principle of the present disclosure should fall within the scope of protection of the present disclosure.

1. An internet-based currency exchange and settlement system, comprising:
at least two legal tender nodes, wherein each of the legal tender nodes is configured to receive an exchange request from a customer and send the exchange request to another one of the legal tender nodes;
an electronic currency node, configures for circulation between electronic currency and legal tender;
a balancing module, configured to establish an exchange path between the electronic currency node and one of the legal tender nodes, to maintain balance between output and input of the legal tender node;
a search module, configured to search for the legal tender node sending an exchange request in a same period as the received exchange request; and
a matching module, configured to match the legal tender nodes with each other or match one of the legal tender nodes with the electronic currency node for exchange.

2. The internet-based currency exchange and settlement method according to claim 1, further comprising an exchange rate calculation module configured to calculate an exchange rate between legal tender and electronic currency and an exchange rate between legal tender and another type of legal tender.

3. The internet-based currency exchange and settlement system according to claim 2, wherein each of the legal tender nodes is connected to a
currency flow monitoring module configured to monitor an output flow and an input flow of legal tender.

4. The internet-based currency exchange and settlement system according to claim 3,
wherein the balancing module is configured to establish an exchange path between the electronic currency and the legal tender based on a signal from the currency flow monitoring module, to maintain balance between inflow and outflow of the legal tender.

5. The internet-based currency exchange and settlement system according to claim 2, further comprising time management module configured to manage a time cycle for currency exchange.

6. The internet-based currency exchange and settlement system according to claim 1, wherein the matching module corresponds to the following exchange matching modes:
exchanging legal tender based on electronic currency, wherein
an exchange rate between held legal tender and target legal tender is determined based on an exchange rate between the held legal tender and the electronic currency and an exchange rate between the target legal tender and the electronic currency, and legal tender exchange between the held legal tender and the target legal tender is performed by taking the electronic currency as a medium; and
exchanging legal tender based on a period, wherein
in a case where a customer A requests for exchange for the target legal tender, a customer B holding the target legal tender and requesting for exchange in a same period is searched for, and legal tender exchange between the held legal tender and the target legal tender is performed based on the exchange rate between the held legal tender and the electronic currency and the exchange rate between the target legal tender and the electronic currency.

7. The internet-based currency exchange and settlement system according to claim 6, wherein
the matching module is further configured to establish a currency flow representing that the held legal tender is exchanged for the target legal tender via the electronic currency, in a case where an amount of the held legal tender exchanged for the target legal tender is greater than an amount of held legal tender exchanged from the target legal tender.

8. (canceled)
